(19) United States
(12) Patent Application Publication
(10) Pub. No.: US 2007/0164088 A1
(43) Pub. Date: Jul. 19, 2007

(54) Brazing process for stainless steel heat exchangers

(76) Inventor: Kam Dianatkhah, Dallas, TX (US)

Correspondence Address: CARSTENS & CAHOON, LLP, P O BOX 802334, DALLAS, TX, 75380, US

(21) Appl. No.: 11/334,252

(22) Filed: Jan. 18, 2006

(51) Int. Cl. B23K 31/02; B23K 35/24

(52) U.S. Cl. 228/183; 228/262.42; 228/262.51

(57) ABSTRACT

An improved brazing process increases the strength and longevity of joints between stainless steel tubes and aluminum fins. The process is especially useful in joining tubes and fins of HVAC secondary heat exchangers and high chrome steels and aluminum. The process is comprised of first plating stainless steel tubes with nickel before applying a brazing flux containing potassium fluoroaluminate complexes such as a NOCOLOK® flux. Subsequently, aluminum fins are pressed to the tubes and flux. The entirety is then brazed in a controlled atmosphere brazing oven. The aluminum becomes metallurgically bonded to the flux, nickel coating, and other constituents of the tubes.

### BACKGROUND

1. Technical Field

This invention relates to a process for brazing aluminum to stainless steel and more particularly to brazing aluminum heat diffusing fins to heat exchange tubes made of stainless steel.

2. Description of Related Art

Many heating furnaces in heating ventilation and air conditioning (HVAC) are comprised of both a primary and a secondary heat exchanger for increased energy transfer efficiency. The primary heat exchanger is usually of a no-weld, crimped aluminized steel S-curve design. The secondary heat exchanger is often comprised of tubes made of corrosion-resistant super high-grade stainless steel with attached aluminum fins. One such stainless steel is AL 29-4C® super high-grade stainless steel (Allegheny Ludlum Corp., Pittsburgh, Pa.). A draft motor blows air over the aluminum fins thus carrying the heat into a living space. Primary and secondary heat exchangers are joined by a stainless steel plate. The secondary heat exchanger allows a furnace to reach higher efficiency levels by capturing more of the available heat. Likewise, aluminum fins offer superior heat transfer properties, but are normally only used in air conditioners since it is extremely difficult to weld or braze aluminum to stainless steel tubes including those made of AL 29-4C® stainless steel.

Stainless steel is normally considered a corrosion resistant metal, but it is very susceptible to stress corrosion cracking (SCC), especially in chloride environments. Stainless steel contains chrome and the chrome creates a chrome oxide film on the surface that protects the stainless steel from further oxidation. However, awkward geometries and mechanical forces exerted at brazed joints further contribute to cracking. Brazing is the process of using heat to couple two metals, usually with a flux. Steel heat exchanger tubes are often very thin and thus are at risk for failure. Additionally, aluminum and steel do not have the same crystalline structure and thus are at a risk for forming weak metallurgical bonds. In particular, aluminum and stainless steel do not readily form strong, resilient metallurgical brazed joints. FIG. 10 is a magnified view of a cross-section of stainless steel and aluminum after these two materials were put into contact with each other and heated to a proper brazing temperature. With reference to FIG. 10, aluminum particles 1004 remain on the outermost surface of the stainless steel 1002 because these two metals do not dissolve well in each other because of their different crystalline forms. These two metals resist forming a brazed joint between them. One reason for this behavior is that aluminum prefers to form face centered cubic (FCC) crystals at all temperatures, and iron prefers to form body centered cubic (BCC) crystals at all temperatures.

Generally, a metallurgical bond could form between aluminum and stainless steel, but due to intermetallic compound formation (i.e. Fe₃Al) at certain aluminum concentrations (during welding or brazing), cracking (not SCC) can initiate. In practice, aluminum is not welded to stainless steels since cracks form, especially between chrome and aluminum, and usually no bonding forms at all.

Stainless steels are normally divided into three groups: austenitic (AISI 200 and 300 series); ferritic (AISI 400 series); and martensitic (also AISI 400 series). Martensitic steels are less resistant to corrosion than the austenitic or ferritic grades. Martensitic stainless steels are used where strength or hardness is of primary concern and where the corrosive environment is relatively mild. Martensitic and ferritic steels contain little or no nickel. Contrarily, some austenitic steel contain nickel and are face-centered cubic (FCC) in crystalline structure.

In general, stainless steels are only susceptible to localized corrosion such as pitting and SCC, not general oxidation or corrosion. Only martensitic and ferritic stainless steels are susceptible to H₂ embitterment, and not austenitic stainless steels such as the 300 series.

Many stainless steels are subject to localized corrosion in an oxygen free environment, stress corrosion cracking, and hydrogen embrittlement. Super stainless steels or duplex stainless steels (steels having a minimum of 11% Cr) have been developed for extremely corrosive environments. These alloys have enhanced levels of chromium, nickel and molybdenum. For example, AL 29-4C® steel is super-ferritic has been developed for the condensing furnace industry, a highly corrosive and high temperature environment.

However, AL 29-4C® steel also does not readily form a strong, resilient metallurgical bond with aluminum. It is still susceptible to SCC, which usually has three prerequisites for its development: tensile stress, corrosive species, and high temperatures. Tensile stress may be residual stress from fabricating operations or applied through the normal operating conditions of the equipment. Tensile stress affects many materials including aluminum and aluminum alloys, nickel alloys, and stainless steels. Corrosive species include a number of ionic compounds including sulfur-containing compounds, NO_{X} compounds, and ammonia and other nitrogen-containing compounds; however, the chloride ion is the most common. In the HVAC environment, nitric acid, sulfur-containing compounds, and chloride may be present in the system.

Temperatures above 140° F. (66 C.), and especially in the range of 140-190° F., are usually contributing factors in SCC failure. One way to reduce SCC is to eliminate the presence of SCC causing chemicals. In addition, proper material selection reduces SCC. Brazing fluxes remove SCC-causing chemicals, oxides, contaminants and corrosive species from base materials to ensure good-quality brazed joints. Brazing fluxes also help reduce residual or tensile stresses. Brazing fluxes used in combination with clean brazing surfaces promote the formation of proper brazed joints. Flux selection depends on the base-material and filler-metal type, heat source, and application method. During brazing, filler metals flow between fitted surfaces of the joint by capillary action. Brazing is effective in joining dissimilar materials such as aluminum to some stainless steels. Heat from brazing is less damaging than that from welding, causing little or no metal vaporization, grain growth, intergranular precipitation, stress corrosion, or distortion. Further, brazed joints have higher strength than do soft-soldered joints. Brazing flux plays an important role in nearly all air-brazing, controlled atmosphere brazing (“CAB”), and vacuum brazing (“VB”) processes.

One such brazing flux which has been used to great success is NOCOLOK® (Solvay Fluor und Derivate GmbH, Hanover, Germany) brazing flux. It dissolves the oxides at brazing temperatures allowing the metals to flow properly. NOCOLOK® brazing flux contains potassium fluoroaluminate complexes which substantially reduce corrosion of aluminum after brazing. Such corrosion is a common problem with the use of traditional brazing fluxes. NOCOLOK® brazing flux complexes comprise, among other species, K₃, AlF₆, and KAlF₄. NOCOLOK® brazing flux is also described as K₁₋₃AlF₄₋₆ or potassium fluoroaluminate complexes in an aqueous solution of a pigment-forming water-soluble compound. From commercial literature, NOCOLOK® brazing flux has the follows proportions of elements: K: 28%-31%; Al: 16%-18%; F: 49%-53%; Fe: 0.03% Max; Ca: 0.2% Max; and water (as measured at 550 C.): 2.5% Max.

Despite the use of prior art processes or methods, it remains difficult to braze some stainless steels to aluminum. In fact, it remains very difficult to braze super ferritic steels to aluminum. Aluminum in the presence of oxygen rapidly oxides to aluminum oxide. Aluminum oxide is brittle and contributes to brazed joint failure, especially in the presence of corrosives. A need exists for a reliable and inexpensive method to produce secondary heat exchangers having resilient aluminum and stainless steel joints. Further, a need exists for a method to quickly and reliably create a multitude of such joints having potentially awkward geometries wherein such geometries are desirable for thermodynamic efficiency. The present invention fills these and other needs as detailed more fully below.

### SUMMARY OF THE INVENTION

An improved brazing method increases the strength and longevity of joints between stainless steel tubes and aluminum fins. The method is especially useful in joining tubes and fins of HVAC secondary heat exchangers. The method is comprised of first plating stainless steel tubes with nickel before applying NOCOLOK® brazing flux to the tubes. Subsequently, aluminum fins are pressed to the tubes and flux. The entirety is brazed in a controlled atmosphere brazing oven. The aluminum fins bond with the nickel, iron, and other elements, and the fins become metallurgically bonded to the tubes thereby forming an improved secondary heat exchanger.

The invention accordingly comprises the features described more fully below, and the scope of the invention will be indicated in the claims. Further objects of the present invention will become apparent in the following detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1A is a front view of a heat exchanger showing aluminum fins attached to steel tubes according to one embodiment of the present invention;

FIG. 1B is a close up cross-sectional view of one portion of FIG. 1A showing the layers of metal at a brazed joint between the aluminum and steel according to one embodiment of the present invention;

FIG. 1C is a magnified cross-sectional view of one portion of FIG. 1B showing an aluminum fin properly brazed to a portion of a steel tube according to one embodiment of the present invention;

FIG. 1D is a magnified cross-sectional view of one portion of FIG. 1B showing the aluminum fin improperly brazed to steel according to the prior art;

FIG. 2 is a table showing the composition of the nickel plating bath used to coat the steel tubes according to one embodiment of the present invention;

FIG. 3 is a flowchart showing the steps of the disclosed novel method according to one embodiment of the present invention;

FIG. 4 is a binary phase diagram of aluminum and iron showing their various phases over a range of temperatures;

FIG. 5 is a binary phase diagram of aluminum and chromium showing their various phases over a range of temperatures;

FIG. 6 is a binary phase diagram of nickel and chromium showing their various phases over a range of temperatures;

FIG. 7 is a binary phase diagram of aluminum and nickel showing their various phases over a range of temperatures;

FIG. 8 is a binary phase diagram of iron and nickel showing their various phases over a range of temperatures;

FIG. 9 is a binary phase diagram of iron and chromium showing their various phases over a range of temperatures; and,

FIG. 10 is a magnified view of a cross-section of stainless steel showing that aluminum forms particles on the surface of the steel instead of mixing with it due to its inherent properties.

### REFERENCE NUMERALS

102 fluid manifold
104 steel tube
106 aluminum fin
108 fluid inlet
110 fluid outlet
112 nickel plating
114 steel tube
118 tube lumen
120 brazed joint
402 FCC phase of Al—Fe mixture
404 BCC phase of Al—Fe mixture
406 liquid phase of Al—Fe mixture
502 FCC phase of Al—Cr mixture
504 BCC phase of Al—Cr mixture
506 liquid phase of al—Cr mixture
602 Cr-rich phase of Ni—Cr mixture
604 Ni-rich phase of Ni—Cr mixture
606 liquid phase of Ni—Cr mixture
702 Ni-rich phases of Al—Ni mixture
704 Al-rich phases of Al—Ni mixture
706 liquid phase of Al—Ni mixture
802 Austenitic (FCC) phase of Fe—Ni mixture
804 Ferritic (BCC) phase of Fe—Ni mixture
806 liquid phase of Fe—Ni mixture
902 Austenitic (FCC) phase of Fe—Cr mixture
904 Ferritic (BCC) phase of Fe—Cr mixture
906 liquid phase of Fe—Cr mixture
1002 stainless steel surface
1004 aluminum particles

### DETAlLED DESCRIPTION

While the invention is described below with respect to a preferred embodiment, other embodiments are possible. The concepts disclosed herein apply equally to other processes and methods to braze aluminum to stainless steel, and more specifically for fusing or connecting aluminum fins to any type of steel pipe or tube. In one embodiment, an aluminum alloy of either AA-3003 or AA-3005 grade is used. Alternatively, other metal alloys may be used in place of aluminum or aluminum alloys. Preferably these other metal alloys contain less than about five percent magnesium so as to accommodate a preferred brazing flux.

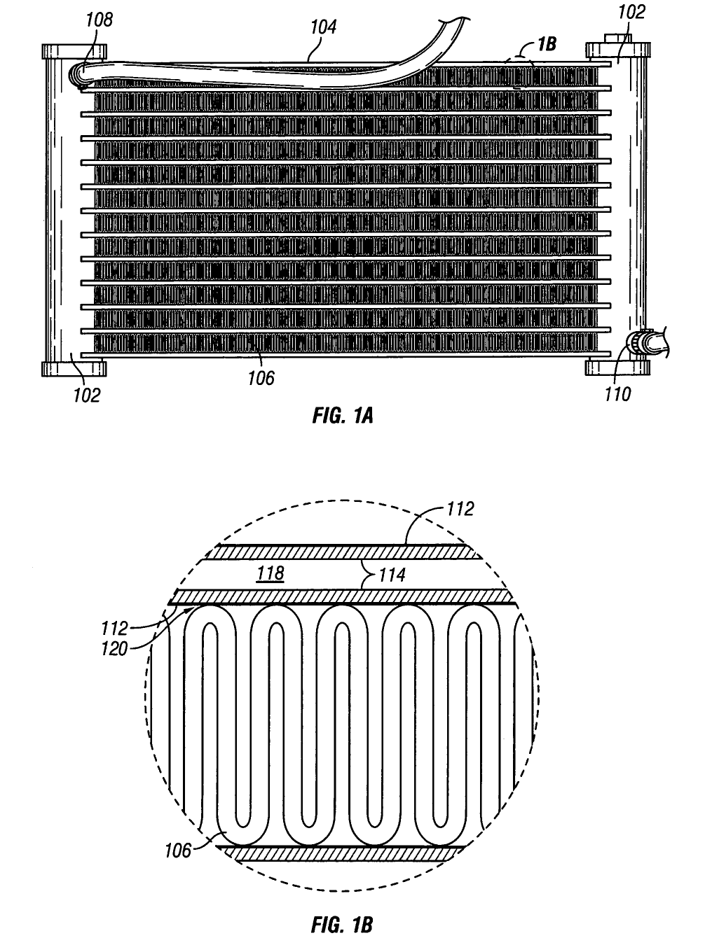

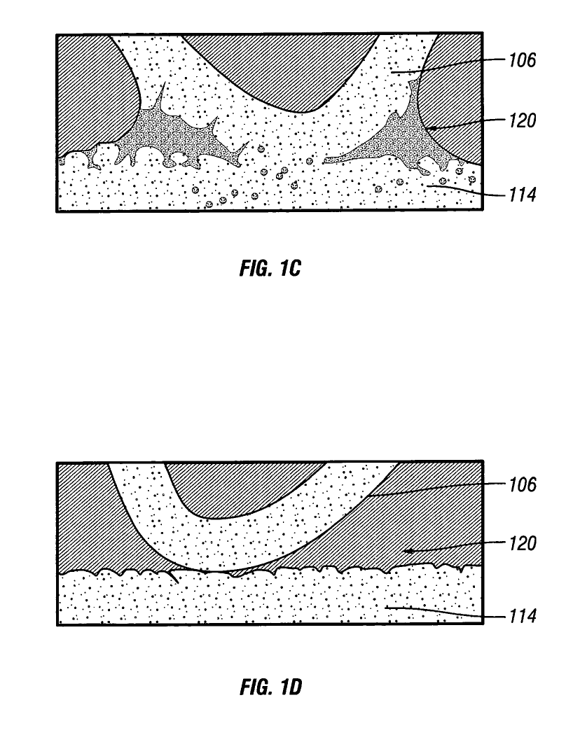

The inventive process comprises brazing steel tubes of heat exchangers to thermal conducting aluminum fins. FIG. 1A shows a typical heat exchanger. With reference to FIG. 1A, fluid enters a fluid manifold 102 through a fluid inlet 108, flows through steel tubes 104 and into a collecting fluid manifold 102 before exiting through a fluid outlet 110. In many heat exchangers, the fluid is corrosive and thus stainless steel is a preferred fabrication material for any component exposed to the fluid. Fins 106 pass between tubes 104 and are connected thereto. Air passes over the outside of the fins 106 and tubes 104 and conducts heat away from the heat exchanger. Fins 106 are often made of aluminum for its thermodynamic properties and inexpensive price.

FIG. 1B shows a close-up view of a small section of the heat exchanger shown in FIG. 1A. With reference to FIG. 1B, fluid flows inside the tube lumen 118. In a preferred embodiment, the steel tube 104 is comprised of steel 114 and a thin layer of nickel 112 on its outside surface. Aluminum fins 106 are brazed to the outer surface forming brazed joints 120 at intervals along the outside of the tube 104.

FIG. 1C shows a properly formed brazed joint according to the present invention. FIG. 1C is a drawing created from an actual photo micrograph of such ajoint. With reference to FIG. 1C, a stainless steel tube 114 is attached to the aluminum fin 106 along a significant region of the stainless steel tube 114. The joint 120 is formed through the fusion of brazing flux, nickel, steel, aluminum, and other elements. FIG. 1D represents a brazed joint between an aluminum fin and a stainless steel tube according to the prior art, and is similarly a drawing created from an actual photo micrograph of such a joint. FIG. 1D is in stark contrast to the properly formed brazed joint in FIG. 1C. With reference to FIG. 1D, the aluminum fin 106 has bonded very poorly to the steel tube 114 as the two are minimally fused at the joint 120. The novel process disclosed herein forms a brazed joint between a steel tube and aluminum fins as shown in FIG. 1C.

There are several steps to this novel process. First, the steel tubes or pipes are coated with nickel or nickel containing compounds. The coating may be applied by electroplating. Next, a brazing flux is applied to either the fins, tubes, or both fins and tubes. Aluminum fins and the steel tubes are then pressed together before the entirety is passed into a brazing furnace wherein the aluminum, nickel, iron, and other elements fuse forming a permanent joint or connection between the tubes and fins. These steps are explained more fully below.

Electroplating and Coating

Nickel plating on metal substrates provides superior corrosion protection and eases brazing of dissimilar metals. In the first step of the current invention for stainless steel, nickel is coated directly on the outer surface of each tube. In one embodiment, the tubes are made of AL 29-4C® stainless steel. AL 29-4C® stainless steel contains almost no nickel. Nickel may be applied to the tubes by one of two commercially preferable means: Electroless nickel (EN) plating and electrolytic plating.

EN plating is a chemical reduction process which depends upon the catalytic reduction of nickel ions in an aqueous solution containing a chemical reducing agent and the subsequent deposition of nickel metal without the use of electrical energy. Due to its exceptional corrosion resistance and high hardness, the process is popular for such items as valves, pump parts, and furnace components such as those disclosed herein to enhance their lifespan especially when exposed to severe service conditions. With effective pre-treatment and accurate control of plating conditions, good adhesion of nickel is obtained. The reductive potential of the EN process is essentially constant at all points of the substrate surface provided the plating solution is sufficiently agitated. Nickel deposits formed through the EN process are therefore very uniform in thickness over the entire treated surface. This process offers distinct advantages when plating irregularly shaped objects, holes, recesses, internal surfaces, valves or threaded parts. Advantages of EN plating comprise: uniformity of the nickel deposits including over complex shapes, less porous deposits which provide better barrier corrosion protection to steel substrates as compared to electroplated nickel and hard chrome, nickel deposits which cause about twenty percent as much hydrogen absorption as electrolytic nickel plating and about ten percent as much hard chrome formation, nickel which can be plated with little or no compressive stress, nickel deposits which have inherent lubricity and non-galling characteristics (an improvement over electrolytic nickel), and low inclusion of phosphorus thereby making the surface solderable.

In one embodiment, EN plating coats the steel tubes with a thin layer of nickel. Such layer is less than about 20 micro-inches (0.5 micrometers) thick. The tubes are first passed through a cleaning bath before being submersed in a solution containing nickel ions. In this embodiment, no electrodes are used. After the nickel is deposited to a desired thickness, the tubes are removed.

In another embodiment, submersed steel tubes are attached to electrodes. Electrical current is applied to the electrodes and nickel is plated on the tubes to a thickness of about 100-700 micro-inches (2.5-18 micrometers). Current or current density (Amp/area) is selected per sample size and coating thickness target. If properly applied, the nickel reacts exothermically with aluminum during brazing. The adhering nickel is sufficient to withstand typical shaping operations used in heat exchanger manufacture.

In one embodiment, the nickel in solution comprises sulfamate nickel, and hypophosphite which is present in the plating solution as sodium hypophosphite. Some of the hypophosphite is reduced to phosphorous, and is co-deposited with nickel to form a NiP alloy. The concentrations of nickel and hypophosphite may need to be replenished as electroplating proceeds. In one embodiment, nickel sulfate and sodium hypophosphite are periodically added to adjust these concentrations.

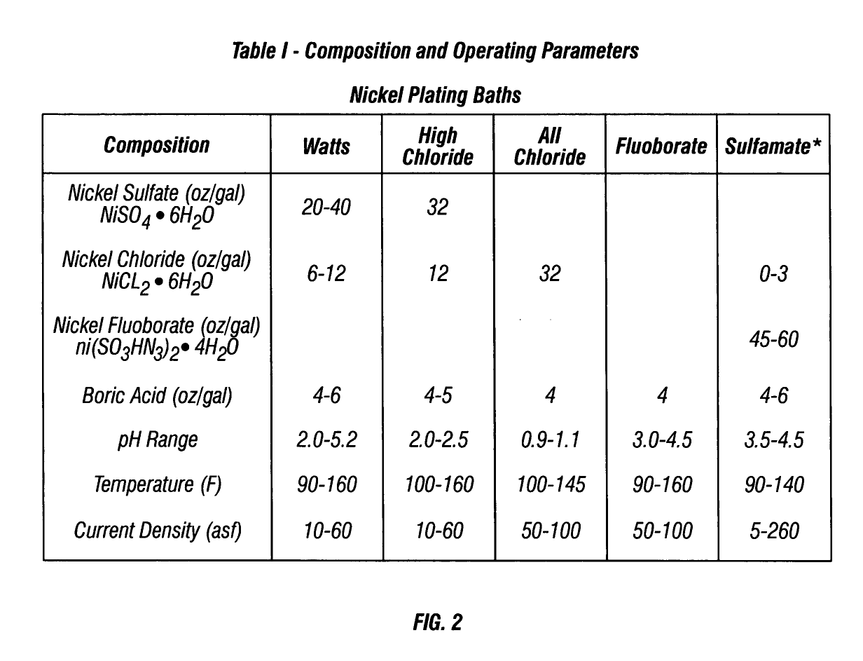

FIG. 2 shows five nickel plating baths wherein each column represents a particular bath, its composition and conditions under which the plating should be performed. With reference to FIG. 2, a first bath titled “Watts” comprises nickel sulfate (NiSO₄.6H₂O), nickel chloride(NiCL₂.6H₂O), and boric acid in solution between 20-40 oz/gal, 6-12 oz/gal, and 4-6 oz/gal, respectively. The pH of the first bath is between 2.0 and 5.2, and the operating temperature is preferably between 90-160° F. The current passed through the electroplating electrodes is between 10-60 amps per square foot (asf).

A second bath titled “High Chloride” comprises nickel sulfate, nickel chloride, and boric acid in solution at about 32 oz/gal, 12 oz/gal, and between 4-5 oz/gal, respectively. The pH of this bath is between 2.0 and 2.5, and the operating temperature is between 100-160° F. The current passed through the electroplating electrodes is between 10-60 asf.

A third bath titled “All Chloride” comprises nickel chloride and boric acid in solution at about 32 oz/gal, and about 4 oz/gal, respectively. The pH of this third bath is between 0.9 and 1.1, and the operating temperature is between 100-145° F. The current passed through the electroplating electrodes is between 50-100 asf.

A fourth bath titled “Fluoborate” comprises boric acid in solution at about 4 oz/gal. The pH of this fourth bath is between 3.0 and 4.5, and the operating temperature is between 90-160° F. The current passed through the electroplating electrodes is between 50-100 asf.

Finally, a fifth bath titled “Sulfamate” comprises nickel chloride, nickel fluoborate (Ni(SO₃HN₃)₂.4H₂O), and boric acid in solution between 0-3oz/gal, 45-60oz/gal, and 4-6 oz/gal, respectively. The pH of the fifth bath is between 3.5 and 4.5, and the operating temperature is preferably between 90-140° F. The current passed through the electroplating electrodes is between 5-260 amps per square foot (asf).

Flux Application

In one embodiment, after electroplating the steel tubes with nickel, a brazing flux is applied. In such embodiment, the flux comprises Cr in an amount of 25 to 35% by weight, P in an amount of 4 to 8% by weight, Si in an amount of 3 to 6% by weight wherein the total amount of P and Si is 9 to 11.5% by weight, at least one selected from a group consisting of Al, Ca, Y and misch metal in an amount of 0.01 to 0.10% by weight, and the balance being Ni-containing compounds and unavoidable impurities. The flux also comprises alkaline chlorides or fluorides, and lithium salts. The lithium salts give these fluxes low melting points, from about 1,0000° to about 1,140° F. (538 C. to 615 C.) and high chemical activity. The lithium salts also dissolve aluminum oxide, an undesireable chemical species present during brazing. In one embodiment, the flux is comprised of tetrafluoro potassium aluminate (KAlF₄) and pentafluoro potassium monohydrate (K₂AlF₅.H₂O).

In a preferred embodiment using flux, NOCOLOK® flux is used. NOCOLOK® flux is a mixture of potassium tetrafluoroaluminate (KAlF₄) and potassium hexafluoroaluminate (K₃AlF₆) which are complexes of potassium fluoride (KF) and aluminum fluoride (AlF₃). This flux is used in the form of an aqueous slurry. The mixing ratio of the slurry is a mixture of potassium fluoroaluminate complexes and water in the range of about 2:100 to about 20:100 by weight. This aqueous slurry is obtained by melting AlF₃ and KF simultaneously in an exact ratio, cooling the resultant mixture, comminuting the cooled mixture into particles of a suitable diameter, generally below 100 mesh, desirably below 150 mesh, and more desirably below 200 mesh, and mixing the comminuted substance with water in a prescribed ratio thereby suspending the substance in water and giving rise to a dilute aqueous slurry. Mesh is defined as the number of openings per inch of a screen. Otherwise, potassium tetrafluoroaluminate and potassium hexafluoroaluminate may be prepared independently of each other and mixed at a prescribed ratio.

In a variation of this embodiment, NOCOLOK® flux is prepared by adding two parts by weight of water to one part by weight of the comminuted mixture thereby producing a dilute slurry and adding a small amount of surfactant during the preparation of the slurry. The relative proportions of KF and AlF₃ used in the preparation of NOCOLOK® flux are desired to approach the ratio of its azeotrope as much as possible. The NOCOLOK® flux, therefore, substantially comprises a mixture of K₃AlF₆ and KAlF₄ of respective amounts to satisfy a KF to AlF₃ ratio (by weight) of about 40:50 to 50:50. It contains substantially no unaltered KF. The NOCOLOK® flux also comprises by weight the following species in the designated ranges: K (28-31%), Al (16-18%), F (49-53%), Fe (max. 0.03%), Ca (max. 0.1%), and LOH (max. 2.5%). Its melting point is 1049-1062° F. (565-572 C.).

In one embodiment, flux is applied to both joint surfaces: the steel tubes and to the aluminum fin assembly before the two materials are pressed together. Alternatively, the flux is applied to just one surface. The geometry of the tubes, and/or the fins may make it difficult to apply the flux. Secondary heater exchangers may use high surface area tubes and waffle-designed aluminum tube fins. Once flux is applied, air may be blown to remove excess water from the components before they are brazed.

The flux may be applied by flooding, spraying, or dipping. A surfactant may be added to the flux to aid wetting and provide uniformity of flux deposition. Air may be blown over the parts to remove any loose particles. A flux coating of about 7×10⁻⁶lb/in² (5 g/m²) is adequate to subsequently form a metallurgical joint between the nickel and the aluminum.

The brazed surfaces should be thoroughly clean prior to NOCOLOK® flux application, especially any aluminum surface. To obtain preferred brazing results, the brazing flux is applied on the entire surface where a brazed connection or joint is desired. Application of flux can be difficult with certain geometries and types of assemblies. For example, because heat exchangers have an abundance of brazed joints, problems can arise because of poor access to certain regions of the heat exchanger parts for proper application of flux. For best brazing results, the brazing flux should be present on the aluminum surface before brazing. In one embodiment, flux is applied by jet spray. The components may be gently washed prior to application of the flux. A degreasing process may be used just prior to brazing. In another embodiment, no flux is applied between the nickel-plated steel tubes and the aluminum fins for secondary heat exchangers. The surfaces are kept clean before being brazed without flux.

Brazing Process

Whether or not flux is applied, the entire apparatus is sent through a drying furnace or drying section of a brazing furnace. The drying furnace slowly heats up the combined or mated components to be brazed. Any moisture or oils from the flux mixture or other source evaporate from the components. In one embodiment, the components are kept very clean so that no thermal de-oiling is required. During drying, care is taken not to heat the components above 390° F. (200 C.), preferably lower, so as to avoid unnecessary oxidation of the metals, especially the aluminum. If moisture is present during brazing, the undesirable corrosive species HF is formed. Unfortunately, the brazing flux after drying can easily fall off due to small mechanical vibrations. Care must be taken to avoid excessive disturbances of the parts during the brazing process.

After drying, the components are heated past the melting point of the NOCOLOK® flux. The components are taken into an atmosphere-controlled section of the furnace (CAB brazing section) wherein the dew point is below −40° F. (−40 C.) and the oxygen concentration is below 100 ppm, and preferably below 40 ppm. Such CAB process can be performed continuously and permits high volumes of brazed assemblies to be produced.

As the components are heated, the brazing flux melts and displaces the aluminum oxide on the surface of the fins and other aluminum parts in contact with the flux and the nickel coating of the tubes. The aluminum then bonds with the aluminum in the flux, if present, and the nickel plated on the tubes. Both nickel and aluminum have a face-centered cubic crystalline structure and thus form a strong metallurgical bond as the fluidized metals intermingle and cool. In one embodiment, the residence time within the entire brazing process is 25 minutes. Other residence times are possible as long as the flux reaches its melting temperature. In one embodiment, the braze temperature is about 1100° F. (593 C.). The time the components spend above 1070° F. (577 C.) is about 3 minutes. In a preferred embodiment, the brazing temperature is about 1090° F. (588 C.). The components are slowly raised to this temperature and kept there for about 3.5 minutes.

The heat exchanger tubes are complete after being removed from the oven. The components are not washed during or after the process. The process of the present invention yields steel tubes joined to aluminum fins by an improved process to form brazed joints between them. The connecting joints are more able to resist mechanical vibrations and provide a thermodynamically efficient connection such that heat energy is readily transferred between the aluminum and steel.

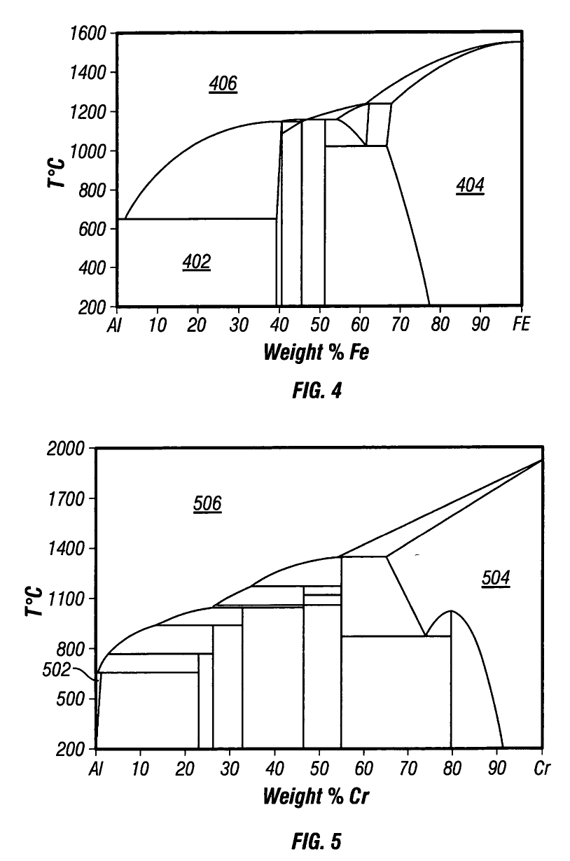

Phase diagrams give some indication about the underlying chemistry occurring at the brazing surface. FIGS. 4, 5, and 7 illustrate the binary phase diagrams of aluminum with iron, chromium, and nickel, respectively. With reference to FIG. 4, the upper phase 406 is the liquid phase of the mixture. The mostly aluminum phase 402 below about 620 C. is an FCC phase, and the mostly iron phase 404 below about 1500 C. is a BCC phase. Similarly, with reference to FIG. 5, the upper phase 506 is the liquid phase of an aluminum and chromium mixture. The mostly aluminum phase 502 below about 660 C. is a small FCC phase, and the large, mostly chromium phase 504 below about 1900 C. is a BCC phase. Iron and chromium prefer to form a different crystal structure than aluminum. FIG. 4 and FIG. 5 show a significant number of intermetallic compounds form when aluminum is brazed to iron or chromium. However, with reference to FIG. 7, below the liquid phase 706, both aluminum and nickel form FCC phases. The mostly aluminum phase 704 below about 620 C. and the mostly nickel phase 702 below about 1400 C. are FCC phases. These two materials, aluminum and nickel, mix well together. In fact, Ni₃Al forms cubic crystals and provides increased strength in steel if both species are present.

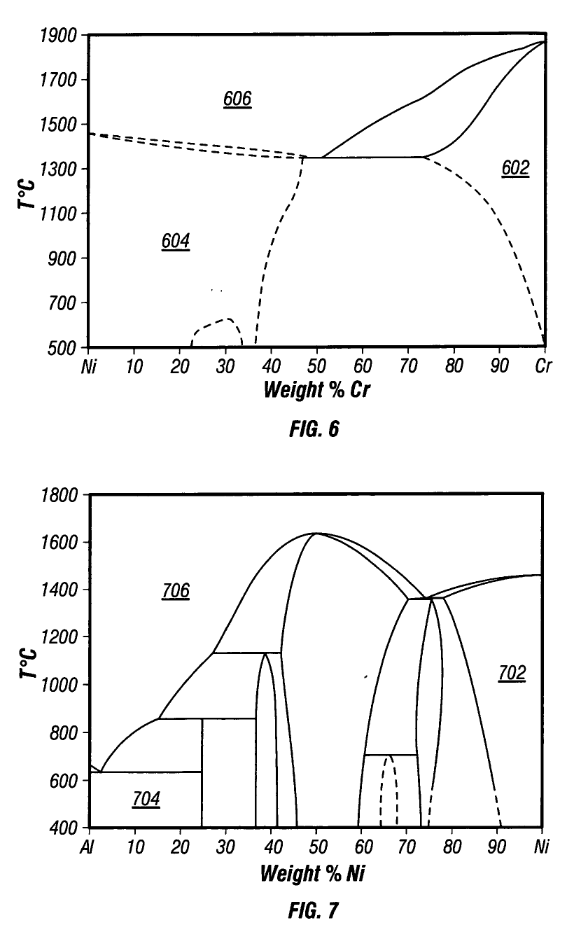

FIG. 6 illustrates a binary phase diagram of nickel and chromium. With reference to FIG. 6, at points below the liquid phase 606, nickel and chromium mix well together. The mostly nickel phase 604 is FCC and the mostly chromium phase 602 is BCC.

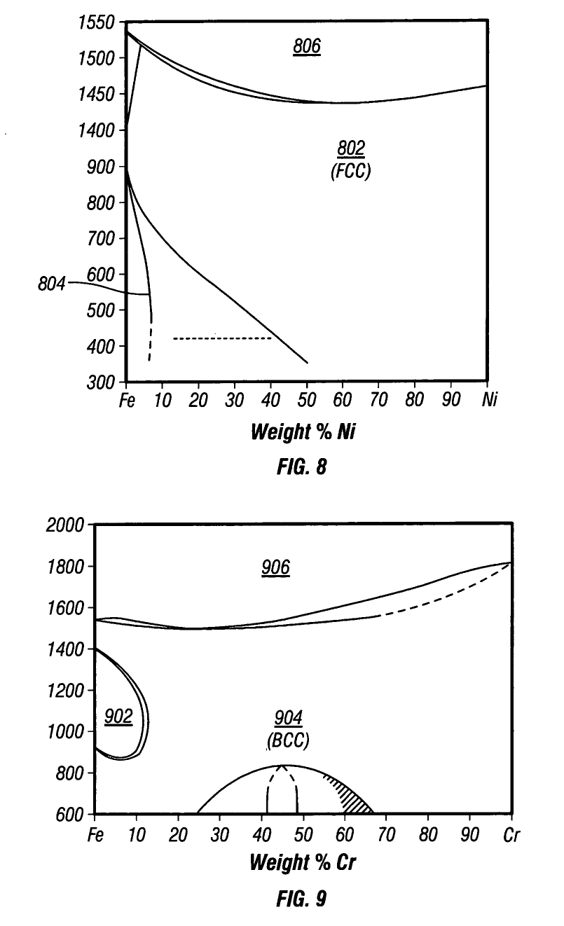

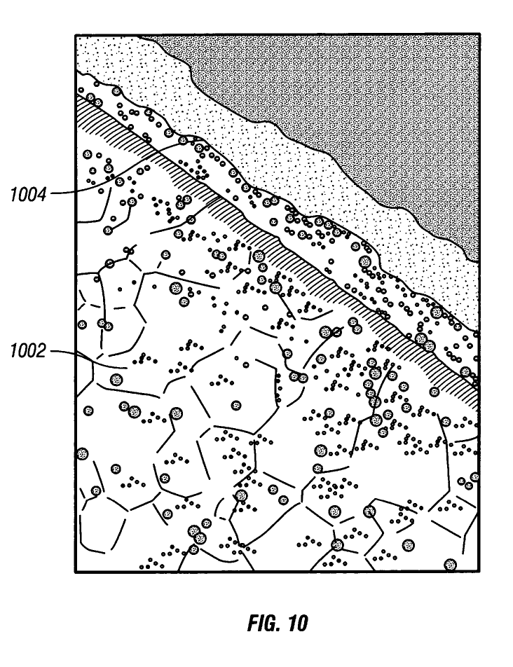

FIG. 8 and FIG. 9 illustrate binary phase diagrams of iron mixed with nickel and chromium, respectively. With reference to FIG. 8, below the liquid phase 806, the addition of nickel drastically shrinks the ferritic phase 804 which is BCC. The mostly nickel phase 802 is austenitic and is FCC. In fact, if enough nickel is added to iron and steel, the mixture is austenitic, stable at room temperature, and remains nonmagnetic. Contrarily, the addition of chromium enlarges the ferritic phase of iron and steel. With reference to FIG. 9, the ferritic phase 904 is expansive and stable, and the austenitic phase 902 is relatively small. The addition of chromium to steel hardens it and impedes the transition to the austenite phase (FCC) during cooling. Chromium and the ferrite phase 904 are both BCC. The effect on austenite can be minimized by adding both chromium and nickel together. Thus, when aluminum is added to iron, nickel, and chromium, (such as during brazing of aluminum fins to the stainless steel tubes), the mixture tends to be austenitic and FCC. Ternary diagrams of nickel, iron and chromium (not shown) also indicate stability of such a mixture and indicate FCC to FCC bonding.

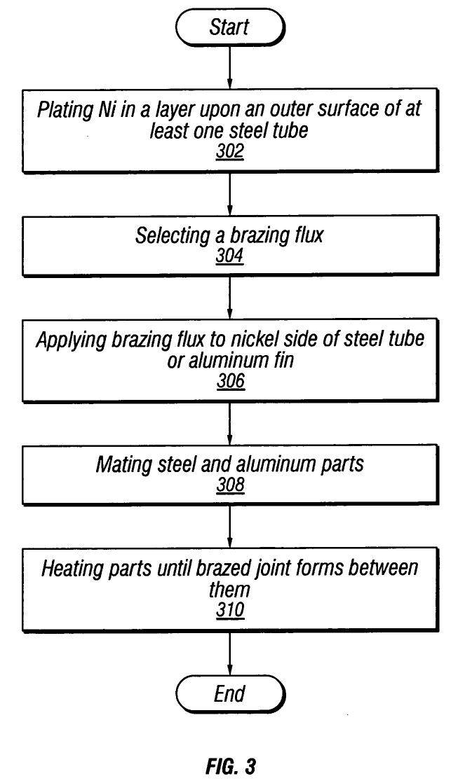

FIG. 3 shows a flowchart as a summary of the disclosed novel method according to one embodiment of the present invention. With reference to FIG. 3, the first step is to plate nickel on the outer surface of a steel tube 302. Next, a brazing flux is selected 304. Preferably, the brazing flux comprises Al, K, and F and has an amount of F between 30 and 60 percent by weight. The next step is to apply brazing flux either on the nickel side of the steel tubes and/or on the aluminum fins 306. Subsequently, the steel and aluminum parts are mated together 308. The last step is to heat the parts until a brazed joint forms between them 310. Once these steps have been completed, the brazed apparatus can be cooled, cleaned and further prepared for service in an HVAC environment.

In summary, the handling of the tubes and fins is as follows. First, the aluminum fins and stainless steel tubes are cleaned and contacted together. Next, the tubes and fins are placed on a belt which carries them through a flux station wherein a coating of brazing flux is applied at the points of contact between them. The tubes and fins are then passed through various sections of a brazing oven: first a drying section, then a preheat section, then through a brazing section, and finally out through a vacuum and cooling section. Afterward, the tubes are leak tested.

The foregoing discussion of the invention has been presented for purposes of illustration and description. Further, the description is not intended to limit the invention to the forms disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternate embodiments to the extent permitted.

I claim:

1. A process for making heat exchangers from steel and aluminum comprising:
(a) plating Ni in a layer upon an outer surface of at least one steel tube;
(b) selecting a brazing flux comprising Al, K, and F wherein the amount of F is between 30 and 60 percent by weight;
(c) applying the brazing flux to at least one surface of either the nickel side of the at least one steel tube or the aluminum;
(d) mating the steel and the aluminum;
(e) heating the mated steel and aluminum in an oven until a metallurgical bond forms between the flux, nickel and aluminum.

2. The process of claim 1 wherein the metallurgical bond of step (e) forms between the flux, nickel, steel and aluminum.

3. The process of claim 1 wherein the at least one steel tube and aluminum in step (e) reach a temperature of at least 1049° F. (565 C.).

4. The process of claim 1 wherein the Ni is plated on only a portion of the at least one steel tube.

5. The process of claim 1 wherein the steel is stainless steel.

6. The process of claim 1 wherein the nickel layer is between 10 micro-inches (0.25 micrometers) and 700 micro-inches (18 micrometers) in thickness.

7. The process of claim 1 further comprising the step of cleaning the aluminum before mating the at least one steel tube with the aluminum.

8. The process of claim 7 wherein the aluminum is cleaned with a substance capable of dissolving aluminum oxide.

9. The process of claim 1 wherein the aluminum is an aluminum alloy comprising at least two percent by weight of Si.

10. At least one steel heat exchanger tube with aluminum fins wherein the aluminum fins are joined to the steel by the process of:
(a) plating Ni in a layer upon an outer surface of the at least one steel tube;
(b) selecting a brazing flux comprising Al, K, and F wherein the amount of F is between 30 and 60 percent by weight;
(c) applying the brazing flux to at least one surface of either the nickel side of the at least one steel tube or the aluminum;
(d) mating the at least one steel tube and the aluminum;
(e) heating the at least one steel tube and aluminum in an oven until a metallurgical bond forms between the flux, nickel and aluminum.

11. The at least one steel tube of claim 10 wherein the metallurgical bond of step (e) forms between the flux, nickel, steel and aluminum.

12. The at least one steel tube of claim 10 wherein the at least one steel tube is made from stainless steel.

13. The at least one steel tube of claim 10 wherein the Ni is plated on only a portion of the at least one steel tube.
